(19) United States
(12) Patent Application Publication
(10) Pub. No.: US 2007/0223588 A1
(43) Pub. Date: Sep. 27, 2007

(54) Method of Searching for a Global Motion Vector

(75) Inventor: Wei Pien Lee, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,502

(22) PCT Filed: May 31, 2005
(86) PCT No.: PCT/IB05/51765

§ 371 Date: Nov. 22, 2006

(30) Foreign Application Priority Data
Jun. 4, 2004 (EP) 04300313.6

(51) Int. Cl. H04N 7/26

(52) U.S. Cl. 375/240.16

(57) ABSTRACT

The present invention relates to a method of searching for a global motion vector associated with a picture of a video sequence, said method comprising the steps of computing (PROJ) projections of pictures (f) along a predetermined axis; determining (PRED) a prediction (v_{pred}(k)) of a current global motion vector formula (I) associated with a current projected picture (F(k)) based on at least one previous global motion vector associated with at least one previous projected picture; determining (SS) a motion vector search set based on the predicted current global motion vector; computing (CAL) a distortion value between a previous projected picture (F(k−1)) shifted of a candidate motion vector (v;(k)) along the predetermined axis and a next projected picture (F(k+r)), said computing step being iterated for the different candidate motion vectors of the motion vector search set, the current global motion vector being the candidate motion vector that minimizes the distortion value.

### FIELD OF THE INVENTION

The present invention relates to a method of and a device for searching for a global motion vector associated with a picture of a video sequence.

It may be used, for example, in mobile apparatuses, such as a camera, a mobile phone or a personal digital assistant PDA.

### BACKGROUND OF THE INVENTION

A conventional approach for motion estimation is to perform block matching between a current block and a set of several candidate blocks according to a distortion measure, and then to select the candidate block giving the smallest distortion. Candidate blocks are chosen thanks to a translation motion whose horizontal and vertical components can be either an integer or a non-integer number of samples. A motion vector MV defines a relative position of the candidate block in the reference picture compared with a block having the same position in the reference picture as the current block in the current picture. The block matching process comprises a step of computing a distortion value between the current block contained in the current picture and a candidate block contained in the reference picture. This computing step is based, for example, on the computing of the sum of absolute error differences SAD between these two blocks. Conventionally, the search area in which the candidate block has to be found has a predetermined size, in general a given number of rows, and every candidate blocks within said search area have to be tested.

In the case of the so-called global motion estimation, a global motion vector is determined by means of a projected picture F, which corresponds to the horizontal (or vertical) sums of an input picture f along a horizontal (or vertical) direction, as shown in equation (1):

$$F ( i , k ) = {\sum }_{j = 0}^{N - 1} f ( i , j , k ) \qquad ( 1 )$$

where i represents a row of the picture, j represents a column of the picture, N represents the number of columns of a picture and k represents time.

A current global vertical motion vector vᵢ^{g}(k) for a current picture F(k) is equal to the candidate vertical global motion vector vᵢ for which the sum of absolute difference SAD between a previous projected picture F(k−1) shifted of the candidate motion vector vᵢ in a first direction along the vertical axis and a next projected picture (F(k+1)) shifted of the candidate motion vector vᵢ in a second direction opposite to the first direction is the smallest, as shown in equation (2):

$${v}_{i}^{g} ( k ) = arg {min}_{{v}_{i} ∈ {S}_{i}^{g}} {\sum }_{i = 0}^{M - 1} \vert F ( i - {v}_{i} , k - 1 ) - F ( i + {v}_{i} , k + 1 ) \vert \qquad ( 2 )$$

where M is the number of rows of the picture and Sᵢ^{g} is the vertical search set.

According to equation (2), it is necessary to test every candidate motion vectors vᵢ within the search set Sᵢ^{g} in order to determine the minimum of the sum of absolute difference SAD. This method is sometimes called the full-search method. However, such a full-search method is particularly computational expensive, especially in case of high-resolution pictures.

### SUMMARY OF THE INVENTION

It is an object of the invention to propose a method of searching for a global motion vector, which is less computational intensive than the one of the prior art.

To this end, the search method in accordance with the invention is characterized in that it comprises the steps of:

computing projections of pictures along a predetermined axis;

determining a prediction of a current global motion vector associated with a current projected picture based on at least one previous global motion vector associated with at least one previous projected picture;

determining a motion vector search set based on the predicted current global motion vector;

computing a distortion value between a previous projected picture shifted of a candidate motion vector along the predetermined axis and a next projected picture, said computing step being iterated for the different candidate motion vectors of the motion vector search set, the current global motion vector being the candidate motion vector that minimizes the distortion value.

As a consequence, the search set only comprises a limited number of candidate motion vectors around the prediction of the global motion vector, whereas the search set is much broader in the prior art, as it is comprised between a lower threshold vₘᵢₙ and a upper threshold vₘₐₓ. Therefore, the present invention allows the computational cost of the search method to be reduced.

According to an embodiment of the invention, the predicted current global motion vector is the previous global motion vector associated with the previous projected picture.

According to a more sophisticated embodiment of the invention, the predicted current global motion vector is an extrapolation of a set of previous global motion vectors associated with a set of previous projected pictures.

According to an embodiment of the invention the search set comprises the range [v_{pred}−n, v_{pred}+n] where v_{pred} is the value of the predicted global motion vector, and n is a positive value. Beneficially, the search set further comprises the motion vector candidate(s) v_{pred}+2q.n where q is an integer different from 0, to the extent that said motion vector candidate(s) lies between a lower threshold vₘᵢₙ and an upper threshold vₘₐₓ.

The present invention also relates to a device for implementing the search method in accordance with the invention.

It relates to a mobile apparatus comprising a screen for displaying a sequence of pictures, such a device for determining a current global motion vector associated with a current picture and means for compensating for a motion of the mobile apparatus based on the current global motion vector.

The invention relates to a video encoder for encoding pictures, said encoder comprising an encoding unit for providing encoded pictures, a decoding unit for providing decoded pictures from the encoded pictures, a prediction unit adapted to deliver motion compensated pictures, an adder for adding the motion compensated pictures to the decoded pictures, the output of said adder being provided to the input of the prediction unit, a subtracter for subtracting the motion compensated pictures from the input pictures, and a device for providing global motion vectors to the prediction unit.

The present invention finally relates to a computer program product comprising program instructions for implementing said method.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a block diagram of the method of searching for global motion vectors according to the present invention;

FIG. 2 is an illustration of a reduced motion vector search set according to the invention; and

FIG. 3 is a block diagram of an encoding device implementing the search method according to the invention.

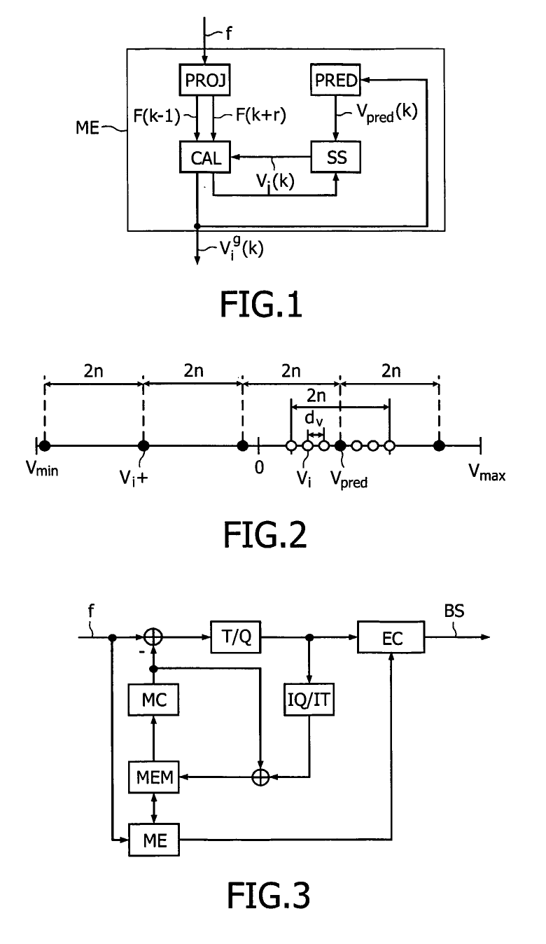

### DETAILED DESCRIPTION OF THE INVENTION

Currently, features that are introduced in high-end products tend to shift to the lower-end products and even to mobile products. However, this shift usually requires more economic implementations of those features or some modifications to fit the market. Frame-rate conversion, interlaced to progressive conversion, and steady shot are examples of features that may be introduced in lower-end and/or mobile products.

The present invention aims at reducing the calculation power required to obtain global motion vectors within a sequence of pictures based on projected pictures. In the context of global motion estimation, the number of SAD operations is equal to the number of candidate motion vectors, as discussed previously. The number of candidate motion vectors is proportional to both the search set and the required resolution of the global motion vectors. A significant reduction of the number of candidate motion vectors is achieved when a prediction of the global motion vector is made. Therefore, a search method implementing said prediction contributes to more consistent motion estimation.

The method of searching for a global motion vector in accordance with the invention first comprises a step PROJ of computing projections F(i) of input pictures f(i,j) along a horizontal or a vertical axis, as described previously in equation (1).

It further comprises a step PRED of determining a prediction v_{pred}(k) of a current global motion vector vᵢ^{g}(k) associated with a current projected picture F(k). The prediction of the current global motion vector is based, for example, on at least one previous global motion vector associated with at least one previous projected picture, respectively.

According to an embodiment of the invention, the prediction of the current global motion vector is equal to the previous global motion vector vᵢ^{g}(k−1) associated with the previous projected picture F(k−1).

According to a more sophisticated embodiment of the invention, the prediction of the current global motion vector is equal to an extrapolation of a set of previous global motion vectors {vᵢ^{g}(k−m), . . . , vᵢ^{g}(k−1)} associated with a set of previous projected pictures {F(k−m), . . . , F(k−1)}, where m is an integer strictly higher than 1. The extrapolation is based, for example, on a Lagrange linear extrapolation. A higher robustness is achieved thanks to the use of this extrapolation technique.

The method in accordance with the invention comprises a step SS of determining a motion vector search set based on the prediction of the current global motion vector. The search of the global motion vector is performed on a local search set around the predicted global motion vector.

According to an embodiment of the invention, the search set comprises the initial search range [v_{pred}−n, v_{pred}+n] where v_{pred} is the value of the prediction of the motion vector, and n is an integer. In this case, the search set comprises 2n+1 values for a full pixel resolution. The accuracy of the global motion vector mainly depends on the size of this initial search set, namely on the value of n.

It will be apparent to a person skilled in the art that n is not necessarily an integer. For example, if more accurate global motion estimation is required, one could shift the projected picture on a sub-pixel basis using interpolation technique. This results in a non-integer global motion vector.

It will also be apparent to a person skilled in the art that the candidate motion vectors of the search set do not have to be equidistant. For example the distance between candidate motion vectors can be based on a quadratic or a logarithmic function. This results in a finer tuning of the global motion vector.

Choosing several candidate motion vectors outside the initial search set increases the robustness of the method. To this end, the search set further comprises additional candidate motion vectors. This has an impact on the way the search method will converge to the actual global motion vector. An example of a set of test vectors is given in FIG. 2. The whole set of candidate motion vectors is described in the following formula:
{∀vₖε└v_{pred}−n, v_{pred}+n┘, v_{pred}+p·dᵥ, pεN}
∪
{∀vₖε[vₘᵢₙ, vₘₐₓ], v_{pred}+2p.n, qεN, q≠0}

where dᵥ is the motion vector unit, which can be non-integer.

It will be apparent to a person skilled in the art that the additional candidate motion vectors of the search set do not have to be equidistant. They can also be determined based on a quadratic or a logarithmic function, as before.

An optimal set of candidate motion vectors for a maximum efficiency of the search method is calculated as follows.
The total number of possible candidate motion vectors is:

$${p}_{max} = \frac{{v}_{max} - {v}_{min}}{{d}_{v}} .$$

The number of candidate motion vectors in the initial search set is:

$$s = \frac{2 n}{{d}_{v}} .$$

The efficiency of the method is as follows:

$$η = \frac{{p}_{max}}{\frac{{p}_{max}}{s} + s - 1} .$$

The optimal search set is derived as follows:

$$\frac{ⅆ ( \frac{{p}_{max}}{s} + s - 1 )}{ⅆ s} = 0 ⇒ {s}_{opt} = \pm \sqrt{{p}_{max}} ,$$

and the maximum efficiency is then:

$$⇒ η = \frac{{p}_{max}}{2 \sqrt{{p}_{max}} - 1} \approx \frac{\sqrt{{p}_{max}}}{2}$$

The search method finally comprises a step CAL of computing a distortion value between a previous projected picture F(k−1) shifted of a candidate motion vector vᵢ(k) along the horizontal or vertical axis and a next projected picture F(k+r), where r is an integer positive or null.

For example in the case of a frame rate up conversion of 2, where a frame must be interpolated on a new instant of time (in this case just in the middle), the distortion value is computed between a previous projected picture F(k−1) shifted of the candidate motion vector vᵢ in a first direction along the horizontal or vertical axis and a next projected picture F(k+1) shifted of the candidate motion vector vᵢ in a second direction opposite to the first direction, as described before in equation (2).

It will be apparent to a person skilled in the art that the shift does not have to be symmetric. For example, in case of a frame rate up conversion of 3, one must interpolate pictures on respectively a ⅓ and ⅔ of the original frame time.

As another example, the previous projected picture F(k−1) could also be shifted with respect to the current projected picture F(k) (i.e. a non shifted projected picture). This method is a lower cost solution which can be used, for example, in picture stabilization.

The computing step is iterated for the different candidate motion vectors of the motion vector search set. The current global motion vector is finally the candidate motion vector that minimizes the distortion value.

Global motion estimation is a metric for the motion in the complete picture, i.e. the average or dominant motion of large or multiple objects with more or less the same motion. It finds its application in the detection of panning (i.e. translation) of objects or camera. It may be used for camera systems as steady shot, where the sudden camera motions are compensated. For display systems it could be part of the pan-zoom model as a refinement for motion estimation for de-interlacing or frame-rate up-conversion.

Said motion estimation as such, can suffice to compensate motion of a video sequence in combination with an appropriate segmentation of the pictures of the sequence. FIG. 3 shows an example of a video encoder. Such a video encoder comprises a first block T/Q comprising a direct frequency transform block in series with a quantizing block Q suitable for producing quantized segmented pictures from the input segmented pictures f, and an entropy coding block EC suitable for producing coded segmented pictures BS from the quantized segmented pictures. The video encoder also comprises a decoding unit comprising in series an inverse quantizing block IQ and an inverse frequency transform block IT for provided decoded segmented pictures. The encoder comprises a prediction unit including an image memory MEM in series with a motion compensation unit MC for producing motion-compensated segmented pictures. It comprises an adder for adding the decoded segmented pictures to the motion-compensated segmented pictures and a subtracter for subtracting the motion-compensated segmented pictures from the input segmented pictures f, the result of this subtracter being delivered to the block T/Q. The video encoder finally comprises the global motion estimation device in accordance with the invention for providing global motion vectors to the prediction unit.

Several embodiments of the present invention have been described above by way of examples only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. A method of searching for a global motion vector associated with a picture of a video sequence, said method comprising the steps of:
computing (PROJ) projections of pictures (f) along a predetermined axis;
determining (PRED) a prediction (v_{pred}(k)) of a current global motion vector (vᵢ^{g}(k)) associated with a current projected picture (F(k)) based on at least one previous global motion vector associated with at least one previous projected picture;
determining (SS) a motion vector search set based on the predicted current global motion vector;
computing (CAL) a distortion value between a previous projected picture (F(k−1)) shifted of a candidate motion vector (vᵢ(k)) along the predetermined axis and a next projected picture (F(k+r)), said computing step being iterated for the different candidate motion vectors of the motion vector search set, the current global motion vector being the candidate motion vector that minimizes the distortion value.

2. A method as claimed in claim 1, wherein the predicted current global motion vector is the previous global motion vector (vᵢ^{g}(k−1)) associated with the previous projected picture (F(k−1)).

3. A method as claimed in claim 1, wherein the predicted current global motion vector is an extrapolation of a set of previous global motion vectors associated with a set of previous projected pictures.

4. A method as claimed in claim 1, wherein the search set comprises the range [v_{pred}−n, v_{pred}+n] where v_{pred} is the value of the predicted global motion vector, and n is a positive value.

5. A method as claimed in claim 4, wherein the search set further comprises the motion vector candidate(s) v_{pred}+2q.n, where q is an integer different from 0, to the extent that said motion vector candidate(s) lies between a lower threshold and a upper threshold.

6. A device for searching for a global motion vector associated with a picture of a video sequence, said device comprising:
means for computing projections of pictures along a predetermined axis;
means for predicting a current global motion vector associated with a current projected picture based on at least one previous global motion vector associated with at least one previous projected picture;
means for determining a motion vector search set based on the predicted current global motion vector;
means for computing a distortion value between a previous projected picture shifted of a candidate motion vector along the predetermined axis and a next projected picture, said computing step being iterated for the different candidate motion vectors of the motion vector search set, the current global motion vector being the candidate motion vector that minimizes the distortion value.

7. A mobile apparatus comprising a screen for displaying a sequence of pictures, a device as claimed in claim 6 for determining a current global motion vector associated with a current picture and means for compensating for a motion of the mobile apparatus based on the current global motion vector.

8. A video encoder for encoding pictures (f), said encoder comprising:
an encoding unit (T/Q,EC) for providing encoded pictures (BS),
a decoding unit (IQ/IT) for providing decoded pictures from the encoded pictures,
a prediction unit (MEM,MC) adapted to deliver motion compensated pictures,
an adder for adding the motion compensated pictures to the decoded pictures, the output of said adder being provided to the input of the prediction unit,
a subtracter for subtracting the motion compensated pictures from the input pictures, and
a device as claimed in claim 6 for providing global motion vectors to the prediction unit.

9. A computer program product comprising program instructions for implementing, when said program is executed by a processor, a method as claimed in claim 1.
